(19) United States
(12) Patent Application Publication
(10) Pub. No.: US 2016/0294903 A1
(43) Pub. Date: Oct. 6, 2016

(54) METHOD AND DEVICE FOR PUSHING RESOURCES TO MOBILE COMMUNICATION TERMINAL BY SMART TELEVISION

(71) Applicant: LE SHI ZHI XIN ELECTRONIC TECHNOLOGY (TIANJIN) LIMITED, Beijing (CN)

(72) Inventor: Hailong HU, ChaoYang District, Beijing (CN)

(21) Appl. No.: 15/036,422

(22) PCT Filed: Nov. 14, 2014
(86) PCT No.: PCT/CN2014/091107

§ 371 Date: May 13, 2016

(30) Foreign Application Priority Data
Nov. 15, 2013 (CN) 201310568389.5

(51) Int. Cl. H04L 29/06; H04W 12/06

(52) U.S. Cl. CPC H04L 65/60; H04W 12/06

(57) ABSTRACT

The present disclosure relates to a method and a device for pushing a resource to a mobile communication terminal by a smart TV. The smart TV establishes a communication connection with the mobile communication terminal in advance, determines a target resource which needs to be pushed to the mobile communication terminal, obtains an IP address of the smart TV and a storage path of the target resource in the smart TV, generates an access address for accessing the target resource according to the IP address and the storage path, determines the mobile communication terminal requesting the target resource, sends the access address to the mobile communication terminal via the communication connection, and when receiving a request for accessing the target resource from the mobile communication terminal, sends the target resource to the mobile communication terminal via the communication connection. The present disclosure realizes convenience and real-time performance of interactions.

### CROSS-REFERENCE TO RELATED APPLICATIONS

This application is based upon and claims priority to Chinese Patent Application 201310568389.5, titled “Method and Device for Pushing Resources to Mobile Communication Terminal by Smart Television”, filed on Nov. 15, 2013, the entire contents of which are incorporated herein by reference.

### FIELD OF TECHNOLOGY

The present disclosure generally relates to the technical field of smart TVs, and more particularly to a method and device for pushing resources to a mobile communication terminal by a smart TV.

### BACKGROUND

With the development of electronic technologies, mobile communication terminals are updated faster than ever, and are also developed and applied increasingly quickly. At present, most mobile communication terminals are equipped with devices such as a wireless device (WiFi), a camera, an acceleration sensor, a touch screen, and a memory. The touch screen replaces the mouse, and the soft keyboard replaces the conventional keyboard. Also, the digital processing capability of mobile communication terminals becomes increasingly powerful. Further, mobile communication terminals are developed towards smart terminals by which people can surf the web to obtain Internet information, play video and audio files, and enjoy interactive games for entertainment.

Among existing TVs, smart TVs are proposed. A smart TV is capable of accessing Internet in a wired or wireless manner and has an external USB port to obtain extended storage space. The smart TV further has functions such as installation and download of application programs, accessing of Internet information and sharing of audio and video contents in TVs. Meanwhile, with the development of TV patterns, there are some TV programs emerged which realize products recommendation and sales using TV media, such as TV shopping, TV advertising, and the like, and thus the use of old TV media is enriched and extended.

Under such background, interactions between mobile communication terminals and smart TVs become a trend. For example, if a user of a mobile communication terminal needs to go out, the user cannot continue to watch or listen to video or audio programs on a smart TV, and has to continue to enjoy the programs until he/she turn on the TV next time. Thus, regret and inconvenience are caused to the user, and consequently convenience and real-time performance of interactions are influenced.

### SUMMARY

In order to realize effective interactions between a smart TV and a user to make the user conveniently obtain resources in the smart TV, embodiments of the present disclosure provide a method for pushing a resource in a smart TV to a mobile communication terminal. The smart TV establishes a communication connection with the mobile communication terminal in advance. The method is applied in the smart TV side and includes:

determining a target resource which needs to be pushed to the mobile communication terminal, wherein the target resource which needs to be pushed to the mobile communication terminal is a resource locally stored in the smart TV;

obtaining an IP address of the smart TV and a storage path of the target resource in the smart TV;

generating an access address for accessing the target resource according to the IP address and the storage path;

determining the mobile communication terminal requesting the target resource, and sending the access address to the mobile communication terminal via the communication connection; and

when receiving a request for accessing the target resource corresponding to the access address from the mobile communication terminal, sending the target resource to the mobile communication terminal via the communication connection.

Optionally, after receiving the request for accessing the target resource corresponding to the access address from the mobile communication terminal, an operating system of the smart TV broadcasts the request to respective background applications. When receiving the request for accessing the target resource corresponding to the access address from the mobile communication terminal, the sending the target resource to the mobile communication terminal via the communication connection, includes:

after receiving the request broadcast by the operating system, determining whether processing the request is authorized; and

if processing the request is authorized, parsing the request, and sending the target resource to the mobile communication terminal via the communication connection.

Optionally, the target resource includes a video file, an audio file, a picture file or a webpage file; when the target resource is a video file or an audio file, the method further includes: sending play position information of the target resource to the mobile communication terminal.

Embodiments of the present disclosure further provide a method for pushing a resource in a smart TV to a mobile communication terminal, wherein the mobile communication terminal establishes a communication connection with the smart TV in advance, the method is applied in the mobile communication terminal side and includes:

providing a user operation entry in a user interface on the mobile communication terminal;

receiving an access address of a resource sent from the smart TV via the communication connection, wherein the access address is generated by the smart TV according to an IP address of the smart TV itself and a storage path of the resource in the smart TV;

when receiving a request for accessing the resource corresponding to the access address from a user via the user operation entry, parsing the access address, and sending an access request to the smart TV via the communication connection according to a parsing result, wherein the access request carries the access address; and

storing or playing the resource according to network resource data returned from the smart TV.

Optionally, the method further includes:

after receiving the access address sent from the smart TV, sending the smart TV information indicating that the access address is received; and

after receiving the network resource sent from the smart TV, sending the smart TV information indicating that the network resource is received.

Optionally, the entry includes a voice input entry or a key input entry.

Optionally, after receiving the network resource sent from the smart TV, an operating system of the mobile communication terminal broadcasts a message indicating that the network resource is received to respective background applications. The storing or playing the resource according to network resource data returned from the smart TV, includes:

after receiving the message broadcast by the operating system, determining whether processing the message is authorized; and

if processing the message is authorized, parsing the message, and storing or playing the resource.

Embodiments of the present disclosure further provide a device for pushing a resource in a smart TV to a mobile communication terminal, including:

a connection module configured to establish a communication connection between the smart TV and the mobile communication terminal in advance;

wherein the device is applied in the smart TV side and further includes:

a determining module configured to determine a target resource which needs to be pushed to the mobile communication terminal, wherein the target resource which needs to be pushed to the mobile communication terminal is a resource locally stored in the smart TV;

an obtaining module configured to obtain an IP address of the smart TV and a storage path of the target resource in the smart TV;

an access address generating module configured to generate an access address for accessing the target resource according to the IP address and the storage path;

an access address sending module configured to determine the mobile communication terminal requesting the target resource, and send the access address to the mobile communication terminal via the communication connection; and

a target resource sending module configured to, when a request for accessing the target resource corresponding to the access address is received from the mobile communication terminal, send the target resource to the mobile communication terminal via the communication connection.

Optionally, after receiving the request for accessing the target resource corresponding to the access address from the mobile communication terminal, an operating system of the smart TV broadcasts the request to respective background applications. The target resource sending module includes:

an authority determining module configured to determine whether processing the request is authorized after the request broadcast by the operating system is received; and

a processing module configured to, if the authority determining module determines that processing the request is authorized, parse the request, and send the target resource to the mobile communication terminal via the communication connection.

Embodiments of the present disclosure further provide a device for pushing a resource in a smart TV to a mobile communication terminal, including:

a connection module configured to establish a communication connection between the mobile communication terminal and the smart TV in advance,

wherein the device is applied in the mobile communication terminal side and further includes:

a user interface module configured to provide a user operation entry in a user interface on the mobile communication terminal;

an access address receiving module configured to receive an access address of a resource sent from the smart TV via the communication connection, wherein the access address is generated by the smart TV according to an IP address of the smart TV itself and a storage path of the resource in the smart TV;

a network resource request module configured to, when a request for accessing the resource corresponding to the access address is received from a user via the user operation entry, parse the access address, and send an access request to the smart TV via the communication connection according to a parsing result, wherein the access request carries the access address; and

a network resource receiving module configured to store or play the resource according to network resource data returned from the smart TV.

Optionally, the device further includes:

a notification module configured to, after the access address sent from the smart TV is received, send the smart TV information indicating that the access address is received, and after the network resource sent from the smart TV is received, send the smart TV information indicating that the network resource is received.

Optionally, the user interface module includes a voice input interface module or a key input interface module.

Optionally, the resource includes a video file, an audio file, a picture file or a webpage file.

Optionally, after receiving the network resource sent from the smart TV, an operating system of the mobile communication terminal broadcasts a message indicating that the network resource is received to respective background applications;

the network resource receiving module includes:

an authority determining module configured to determine whether processing the message is authorized after the message broadcast by the operating system is received; and

a processing module configured to, if the authority determining module determines that processing the message is authorized, parsing the message, and store or play the resource.

Embodiments of the present disclosure further provide a device for pushing a resource in a smart TV to a mobile communication terminal, wherein the smart TV establishes a communication connection with the mobile communication terminal in advance, the device is applied in the smart TV side and includes:

one or more processors; and

a memory;

wherein one or more programs are stored in the memory, and when executed by the one or more processors, the one or more programs cause the one or more processors to:

determine a target resource which needs to be pushed to the mobile communication terminal, wherein the target resource which needs to be pushed to the mobile communication terminal is a resource locally stored in the smart TV;

obtain an IP address of the smart TV and a storage path of the target resource in the smart TV;

generate an access address for accessing the target resource according to the IP address and the storage path;

determine the mobile communication terminal requesting the target resource, and send the access address to the mobile communication terminal via the communication connection; and

when receive a request for accessing the target resource corresponding to the access address from the mobile communication terminal, send the target resource to the mobile communication terminal via the communication connection.

Optionally, wherein after receiving the request for accessing the target resource corresponding to the access address from the mobile communication terminal, an operating system of the smart TV broadcasts the request to respective background applications; and

wherein the one or more processors are configured to:

after receive the request broadcast by the operating system, determine whether processing the request is authorized; and

if processing the request is authorized, parse the request, and send the target resource to the mobile communication terminal via the communication connection.

Embodiments of the present disclosure further provide a device for pushing a resource in a smart TV to a mobile communication terminal, wherein the mobile communication terminal establishes a communication connection with the smart TV in advance, the device is applied in the mobile communication terminal side and includes:

one or more processors; and

a memory;

wherein one or more programs are stored in the memory, and when executed by the one or more processors, the one or more programs cause the one or more processors to:

provide a user operation entry in a user interface on the mobile communication terminal;

receive an access address of a resource sent from the smart TV via the communication connection, wherein the access address is generated by the smart TV according to an IP address of the smart TV itself and a storage path of the resource in the smart TV;

when receive a request for accessing the resource corresponding to the access address from a user via the user operation entry, parse the access address, and send an access request to the smart TV via the communication connection according to a parsing result, wherein the access request carries the access address; and

store or play the resource according to network resource data returned from the smart TV.

Optionally, wherein the one or more processors are further configured to:

after receive the access address sent from the smart TV, send the smart TV information indicating that the access address is received; and

after receive the network resource sent from the smart TV, send the smart TV information indicating that the network resource is received.

Optionally, wherein the entry comprises a voice input entry or a key input entry.

Optionally, wherein the target resource comprises a video file, an audio file, a picture file or a webpage file.

Optionally, wherein after receiving the network resource sent from the smart TV, an operating system of the mobile communication terminal broadcasts a message indicating that the network resource is received to respective background applications; and

wherein the one or more processors are configured to:

after receive the message broadcast by the operating system, determine whether processing the message is authorized; and

if processing the message is authorized, parse the message, and store or play the resource.

Since the resources in a smart TV may be conveniently pushed to a mobile communication terminal, users can enjoy local resources of the TV on the mobile communication terminal anywhere, which brings great convenience to users. Further, users may receive information in the TV by the mobile communication terminal timely, and convenience and real-time performance of interactions are realized.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements.

FIG. 1 is a flowchart showing a method according to a first embodiment of the present disclosure;

FIG. 2 is a flowchart showing a method according to a second embodiment of the present disclosure.

FIG. 3 is a block diagram showing an architecture of program modules corresponding to the first embodiment; and

FIG. 4 is a block diagram showing an architecture of program modules corresponding to the second embodiment.

### DESCRIPTION OF THE EMBODIMENTS

Exemplary embodiments of the present disclosure will be described below in detail with reference to drawings. Even though exemplary embodiments of the present disclosure are presented in drawings, it shall be appreciated that the present disclosure may be practiced in various manners without being limited to the embodiments set forth herein. Instead, the embodiments are provided herein to make the present disclosure be understood more thoroughly and to more completely convey the scope of the present disclosure to one of ordinary skill in this art.

Embodiments of the present disclosure may be performed by a smart TV or a mobile communication terminal such as a mobile phone. A user may use the terminal to control the smart TV, for example, sending commands to the smart TV to request data. The smart TV may serve as a server of the mobile communication terminal to provide data services for the mobile communication terminal, generally the data locally stored in the smart TV, for example resource data such as audios, video files, picture files or webpages. In specific implementations, the mobile communication terminal and the smart TV operate independently from each other and meanwhile interact with each other, and they work together to realize the technical solutions provided by embodiments of the present disclosure.

To facilitate understanding, it shall be explained that in embodiments of the present disclosure, an application program (APP) running on the mobile communication terminal device may be provided, for example, called as “TV assistant”. A user may install the APP on his/her own mobile terminal device. Correspondingly, an operating system in the smart TV side may have corresponding background application programs installed therein to interact with the TV assistant in the mobile terminal device side and thereby to realize a function of pushing resources to the mobile communication terminal. Since the pushed resources are locally stored in the smart TV, in the embodiments of the present disclosure, the resources in the smart TV end are called as local resources, and the resources to be pushed to the mobile communication terminal device are called as target resources. In the mobile communication terminal side, the requested and received resources are called as network resources.

In the situation where the TV assistant is installed on the mobile communication terminal device and the smart TV has corresponding background applications therein, the smart TV and the mobile communication terminal device are connected to the same local area network, for example, connected to networks via the same Wireless Fidelity (WiFi) connection. In this way, the TV assistant in the mobile communication terminal may establish a communication connection with the smart TV by private communication protocols, and subsequent signals and data may be transmitted based on the established communication connection. Specifically, after the communication connection is established between the mobile communication terminal and the smart TV by a certain port, respective background application programs in the smart TV side (a plurality of application programs may be installed in the smart TV, and sometimes multiple application programs run at background simultaneously to realize respective functions, and the running application programs may include the application program for resource pushing operation) can listen on messages received at the port. The message interactions may be implemented as follows. After the mobile communication terminal device side sends a message to the smart TV side, the operation system in the smart TV side can receive the message and broadcast the received message to respective background applications in the smart TV. After receiving the message, the respective background applications may determine whether the message needs to be processed by themselves. If the message needs to be processed, the respective background applications perform subsequent operations such as parsing; and if the message does not need to be processed, the background applications may discard the message. Similarly, after the communication connection is established, the background application programs in the mobile communication terminal side may listen on the messages received at the communication port to determine whether the messages need to be processed. If there is a message sent from the smart TV, the operating system in the mobile communication terminal side can receive the message, and broadcast the message to respective background applications. Then, the application programs in the mobile communication terminal determine whether the message needs to be processed by themselves. If the message needs to be processed, the applications may receive the broadcast and perform subsequent operations such as parsing; and if the message does not need to be processed, the application programs may discard the message. For example, if the TV assistant in the mobile communication terminal receives the broadcast, and determines that the broadcast needs to be processed by the TV assistant itself, the TV assistant performs subsequent operations such as parsing.

### First Embodiment

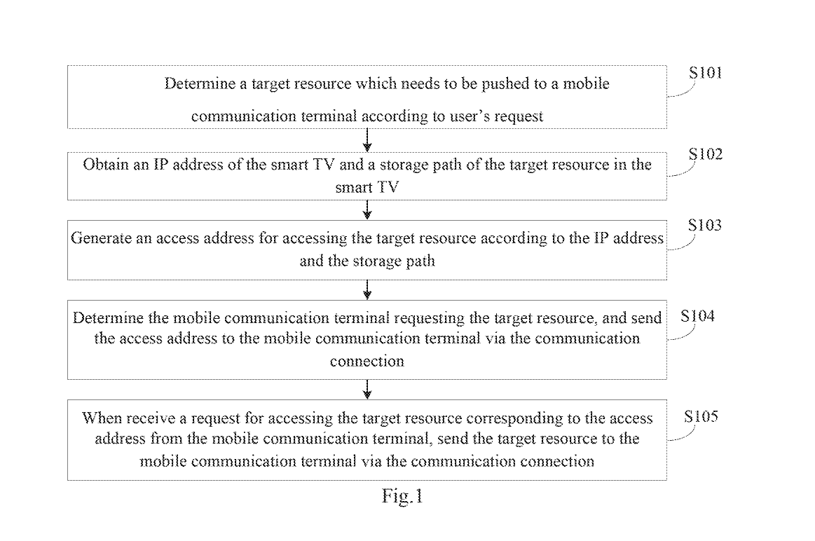

Firstly, the first embodiment provides a method for pushing a resource in a smart TV to a mobile communication terminal from the point of view of the smart TV. The method is performed by a smart TV which interacts with a mobile communication terminal. Referring to FIG. 1, the specific procedure is as follows.

In step S101, a target resource which needs to be pushed to the mobile communication terminal is determined. The target resource which needs to be pushed to the mobile communication terminal is a resource locally stored in the smart TV.

Background programs in the smart TV may listen on commands sent by a remote of the TV, determine whether there is a request for pushing resources outwardly, and determine a target resource to be pushed after receiving the request. The target resource to be pushed may be a resource which is being played or displayed currently, or may be a resource stored under a certain directory. For the former case, if a push request is received by the remote during the playing or displaying of a resource, the smart TV may determine the resource which is being played or displayed currently as the target resource. For the latter case, there are many folders in the smart TV and files of different types or from different channels may be put in different folders. Under such condition, if a push request is received in a case where multiple files are displayed in a specific folder, and a certain file in the folder is selected, the selected file may be determined as the target resource to be pushed.

If the target resource to be pushed is the resource which is being played or displayed currently and the resource is an Internet resource accessed by the smart TV via Internet, the smart TV downloads the Internet resource locally and determines the resource as the resource to be pushed. If the target resource to be pushed is the resource which is being played or displayed currently and the resource is a resource stored locally in the smart TV, the smart TV may directly determine the resource as the resource to be pushed.

In step S102, an IP address of the smart TV and a storage path of the target resource in the smart TV are obtained.

In embodiments of the present disclosure, the resource to be pushed to the mobile terminal device is a resource locally stored in the smart TV. For example, the target resource may be a photo pushed from a mobile terminal device A to the smart TV, and in the embodiments of the present disclosure, the photo may be further pushed to another mobile terminal device B. As another example, the target resource may be a video downloaded into the smart TV from Internet, and in the embodiments of the present disclosure, the downloaded video may be further pushed to a mobile terminal device. That is to say, the resources locally stored in the smart TV may be pushed to a mobile terminal device. The resources locally stored in the smart TV are different from the resources from a cloud-end server or a third-party website, because the resources are not the resources which all users can access via networks but privates resources owned by the owner of the smart TV device. Such resources do not need to be located in the networks, and thus do not have a network access address. However, in the embodiments of the present disclosure, in order to make a recipient user access the resources pushed to him/her normally, it is needed to construct an access address for accessing the target resource to be pushed. In other words, in the embodiments of the present disclosure, the smart TV pushes resources to the mobile communication terminal as a server, and thus the resources in the smart TV need access addresses recognizable by the mobile communication terminal to perform data transmission. When constructing such access address, a storage path of the target resource in the smart TV may be obtained as a first part of the access address, and an IP address of the smart TV may be obtained as a second part of the access address.

In step S103, an access address for accessing the target resource is generated according to the IP address and the storage path.

The IP address of the smart TV and the storage path of the target resource are combined according to a certain rule to generate the access address of the target resource. The address corresponds to the resource in the smart TV, and a user may find the requested target resource by accessing the access address.

In step S104, the mobile communication device requesting the target resource is determined, and the access address is sent to the mobile communication terminal via the communication connection.

In a connection list of the smart TV, there may be a plurality of devices which are connected to the smart TV by private protocols. The user may select a mobile communication terminal which requests the target resource by the remote, and send the access address to the mobile communication terminal by the established communication path with the mobile communication terminal after the selection.

In step S105, when a request for accessing the target resource corresponding to the access address is received from the mobile communication terminal, the target resource is sent to the mobile communication terminal via the communication connection.

The background operating system of the smart TV listens on commands from the mobile communication terminal. When receiving a command from the mobile communication terminal for accessing the target resource corresponding to the above access address, the operating system broadcasts a message indicating that the command is received to respective application programs. After receiving the broadcast, the respective application programs of the smart TV determine whether the broadcast needs to be processed by themselves. For example, if the resource pushing application program determines that itself is authorized to process the message, the resource pushing application program parses the message, finds the resource according to the path of the resource and sends the resource to the mobile communication terminal via the existing connection.

Optionally, if the resource pushed by the smart TV is an audio file or a video file, and the audio file or the video file is being played by the smart TV or a part of the file has been played by the smart TV during determining of the target resource to be pushed in step S101, information regarding a play position of the target resource played in the smart TV may be sent to the mobile communication terminal concurrently with the target resource. For example, if a 45-minute video has been played for twenty minutes. As another example, a video file is a streaming media, and the 500M of the 1 G streaming media has been played. When receiving the play position information, the mobile communication terminal may continue to play the parts which have not been played yet according to the play position information without replaying the parts which have been played.

Using the embodiment, when the mobile communication terminal receives an audio or video pushed by the smart TV, a user may enjoy the audio or video in the TV anywhere, and the user may continue to play the audio or video on the mobile communication terminal according to the received play position information, and thus user experience is improved.

In conclusion, in the embodiment, a target resource a user wants to push may be selected on a smart TV by using a remote, and an access address of the resource may be sent to the user side by a private protocol. If the user requests to send the corresponding target resource, the smart TV may further send the target resource to the user. Since there are abundant local resources in the smart TV, the smart TV may serve as a server of the mobile communication terminal to push the local resources to the mobile communication terminal as the target resources. Accordingly, the user may obtain the resources conveniently, and watch the programs anywhere and anytime. Even if the user needs to go out, the user may continue to enjoy his/her favorable programs without regret. Further, convenience and real-time performance of interactions are realized.

### Second Embodiment

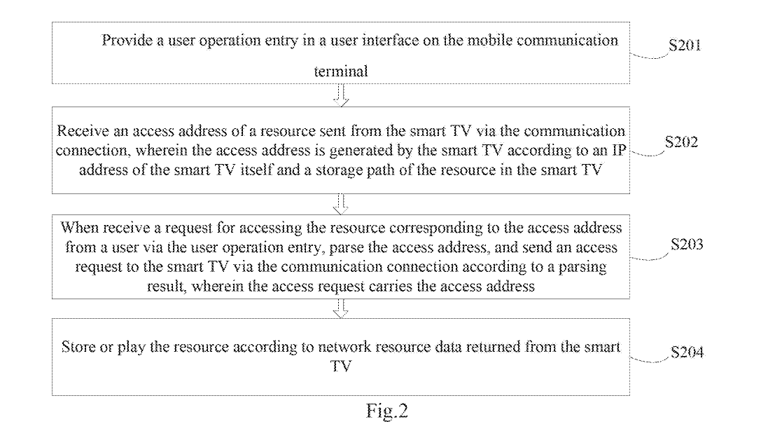

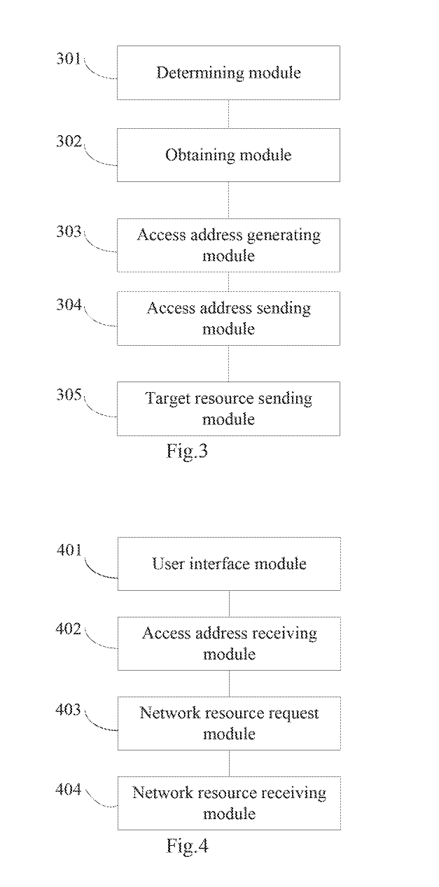

The solutions of the present disclosure will be described by a second embodiment from the point of view of a mobile communication terminal. The mobile communication terminal mainly performs the method according to the second embodiment. Specifically, in the embodiment, how the mobile communication terminal interactively communicates with a smart TV and how the mobile communication terminal receives network resources from the smart TV are described. The operations performed by the mobile communication terminal are corresponding to the relevant operations performed by the smart TV in the first embodiment. As briefly introduced below, the procedure is shown in FIG. 2.

After the mobile communication terminal establishes a communication connection with the smart TV, the following operations are performed.

In step S201, a user operation entry is provided in a user interface on the mobile communication terminal.

Applications such as TV assistant are installed in the mobile communication terminal side. Thus, a user interface may be provided to a user by the application, and meanwhile specific user operation entry such as a button may be provided in the user interface. In this way, after the user starts the TV assistant application in the mobile communication terminal device, such operation entry may be viewed in the user interface. When the user performs corresponding operations such as tapping by the operation entry, equivalently, the TV assistant receives a user instruction.

In step S202, an access address of a resource sent from the smart TV is received via the connection. The access address is generated by the smart TV according to an IP address of the smart TV itself and a storage path of the resource in the smart TV.

The smart TV requests a background network program to return an IP address of the smart TV and a storage path of the determined target resource, and combines the IP address and the storage path to generate a new access address. Since the mobile terminal user has established a connection with the smart TV, the mobile terminal may receive the access address of the network resource in the smart TV via the connection. The address is corresponding to the network resource in the smart TV, and the user may find the request network resource by receiving and accessing the access address.

In step S203, when a request for accessing the network resource corresponding to the access address is received from a user via the user operation entry, the access address parsed, and an access request is sent to the smart TV via the communication connection according to a parsing result. The access request carries the access address.

The user may send an instruction to the TV assistant by the user operation entry in the TV assistant, and then the TV assistant may send various operation commands to the smart TV. The implantation of the step includes two interactions, i.e., the interaction between the user and the mobile communication terminal device, and the interaction between the mobile communication terminal device and the smart TV. Firstly, the user interacts with the mobile communication terminal device. The specific implementation of the interaction between the user and the mobile communication terminal device is related to the implementation of the user operation entry. The user operation entry may be implemented in various manners, and accordingly, the interaction between the user and the mobile communication terminal device may be implemented in many ways.

For example, at present, most mobile phones are equipped with a touch screen. Thus, the user operation entry may be provided by an operable button presented in the user interface, and the user may tap a corresponding button on the touch screen to send the instruction for requesting network resources. Alternatively, a draggable sliding block and a sliding direction may be presented in the user interface to provide user operation entry. In this way, the user may drag the sliding block to send the instruction for requesting resources, and the like. For the TV assistant, no matter what specific interaction manner is used by the user to submit the instructions, the TV assistant may generate corresponding commands and send the commands to the smart TV side via the communication connection.

Alternatively, in another implementation, a button for voice input may be provided in the user interface of the TV assistant as the user operation entry. After the user taps the voice input button, voice input devices on the mobile communication terminal device such as a microphone may be started to receive the voice information input by the user. For example, the user may speak “Request**resource” to the microphone of the mobile communication terminal device, and accordingly the TV assistant may recognize the voice input signals and generate a corresponding command, and then send the command to the smart TV after the command is confirmed by the user.

After the command is sent, the background network program in the mobile communication terminal generates a data packet which includes the user instruction for requesting the network resource and the access address corresponding to the resource. The mobile communication terminal sends the data packet to the smart TV via a network which both the mobile communication terminal and the smart TV are connected to so as to request corresponding network resource.

In step S204, the resource is stored or played according to network resource data returned from the smart TV.

After the smart TV sends the network resource as requested by the user to the mobile communication terminal, the background operating system of the mobile communication terminal receives a message regarding the network resource and broadcasts the message to respective background applications. The respective background applications determine whether the message needs to be processed by themselves. For example, if the TV assistant in the mobile communication terminal receives the broadcast and determines that the message needs to be processed by the TV assistant itself, the TV assistant parses the message, and receives the resource via the network. If the user does not need to play the program in the resource immediately, the resource may be stored in a memory. Or, if the user needs to watch the program immediately, a video play program may be called to play the program in the resource.

Optionally, if the network resource returned by the smart TV is an audio or video resource and the returned network resource data further includes the information regarding the play position of the network resource played in the smart TV, when the mobile communication terminal receives and plays the resource in step S204, the mobile communication terminal may continue to play the parts of the resource which are not played according to the received play position information without replaying the parts which have been played.

In conclusion, in the embodiment, an operation entry for requesting resources in a smart TV may be provided to a user in a mobile communication terminal device side. In this way, the user may send a corresponding instruction by directly operating the mobile communication terminal. Then, the mobile communication terminal device may automatically send a message for requesting a network resource to the smart TV via a communication connection which is established in advance. After receiving the message, the smart TV may send corresponding resource to the user side. Since most existing mobile communication terminal devices have a very friendly user interface, and various functions and operations are easy to study, the user can find the function for network resource pushing from the mobile communication terminal more readily as compared with a remote. Further, existing mobile communication terminals generally have a touch screen or a voice function, and thus commands may be sent to the smart TV only with a tap by a finger or saying of a word. Thus, the operation is more simple, convenient and fast.

On the basis of the second embodiment, further improvements may be performed in the present disclosure. Specifically, after receiving the access address sent from the smart TV, the mobile communication terminal may send the smart TV information indicating that the access address is received. After receiving the network resource sent from the smart TV, the mobile communication terminal may send the smart TV information indicating that the network resource is received. Thus, real-time performance of the interactions is guaranteed.

Further, the present disclosure provides a device corresponding to the first embodiment, i.e., a device for pushing a resource in a smart TV to a mobile communication terminal. The device includes a connection module configured to establish a communication connection between the smart TV and the mobile communication terminal in advance. The device is applied in the smart TV side and further includes a determining module 301, an obtaining module 302, an access address generating module 303, an access address sending module 304 and a target resource sending module 305.

The determining module 301 is configured to determine a target resource which needs to be pushed to the mobile communication terminal. The target resource which needs to be pushed to the mobile communication terminal is a resource locally stored in the smart TV.

The obtaining module 302 is configured to obtain an IP address of the smart TV and a storage path of the target resource in the smart TV.

The access address generating module 303 is configured to generate an access address for accessing the target resource according to the IP address and the storage path.

The access address sending module 304 is configured to send the access address to the mobile communication terminal via the communication connection.

The target resource sending module 305 is configured to, when a request for accessing the target resource corresponding to the access address is received from the mobile communication terminal, send the target resource to the mobile communication terminal via the communication connection.

After receiving the request for accessing the target resource corresponding to the access address from the mobile communication terminal, an operating system of the smart TV broadcasts the request to respective background applications. The target resource sending module includes an authority determining module and a processing module.

The authority determining module is configured to determine whether processing the request is authorized after the request broadcast by the operating system is received.

The processing module is configured to, if the authority determining module determines that processing the request is authorized, parse the request, and send the target resource to the mobile communication terminal via the communication connection.

The present disclosure further provides a device corresponding to the second embodiment, i.e., a device for pushing a resource in a smart TV to a mobile communication terminal. The device includes a connection module configured to establish a communication connection between the mobile communication terminal and the smart TV in advance. The device is applied in the mobile communication terminal side and further includes a user interface module 401, an access address receiving module 402, a network resource request module 403, and a network resource receiving module 404.

The user interface module 401 is configured to provide a user operation entry in a user interface on the mobile communication terminal.

The access address receiving module 402 is configured to receive an access address of a resource sent from the smart TV via the communication connection. The access address is generated by the smart TV according to an IP address of the smart TV itself and a storage path of the resource in the smart TV.

The network resource request module 403 is configured to, when a request for accessing the resource corresponding to the access address is received from a user via the user operation entry, parse the access address, and send an access request to the smart TV via the communication connection according to a parsing result. The access request carries the access address.

The network resource receiving module 404 is configured to receive and store or play the resource according to network resource data returned from the smart TV.

In order to enhance the real-time performance of the interactions between the smart TV and the mobile communication terminal, the device further includes a notification module.

The notification module is configured to, after the access address sent from the smart TV is received, send the smart TV information indicating that the access address is received, and after the network resource sent from the smart TV is received, send the smart TV information indicating that the network resource is received.

The user interface module may include a voice input interface module or a key input interface module.

Further, after receiving the network resource sent from the smart TV, an operating system of the mobile communication terminal broadcasts a message indicating that the network resource is received to respective background applications.

The network resource receiving module includes an authority determining module and a processing module.

The authority determining module is configured to determine whether processing the message is authorized after the message broadcast by the operating system is received.

The processing module is configured to, if the authority determining module determines that processing the message is authorized, parse the message, and store or play the resource.

It shall be noted that the present disclosure is not limited to any particular programming language. One of ordinary skill in this art can appreciate that the modules in the devices of the embodiments may change adaptively and the modules may be arranged in one or more devices different from the embodiments. The modules or components in embodiments may be combined into one module or component. Or, the modules or components in embodiments may be divided into a plurality of sub-modules or sub-components. Except that at least some of such features and/or processes or modules are mutually exclusive, all the features and any method or all the processes of the device or modules disclosed in the present disclosure may be combined in any manner. Each feature disclosed in the present disclosure may be replaced by the same or equivalent features or substitute features for similar purposes, unless stated otherwise.

Respective parts in embodiments of the present disclosure may be implemented by hardware, or by software modules running on one or more processors, or a combination thereof. One of ordinary skill in this art can appreciate that, in practice, microprocessors or digital signal processors (DSPs) may be used to realize a part or all of the functions of some or all of the devices for processing, providing or downloading the network multimedia resource information in embodiments of the present disclosure. The present disclosure may be also implemented as devices or apparatus or programs for performing a part or all of the methods described herein. Such programs for realizing the present disclosure may be stored in a computer-readable medium, or may have a form of one or more signals. Such signals may be downloaded from Internet websites, or provided on a carrier signal, or provided by any other forms.

It shall be noted that the above embodiments are provided for the purposes of illustrating but not limiting the present disclosure, and one of ordinary skill in this art may design alternative embodiments without departing from the scope of the appended claims. The word “a” or “one” before an element does not exclude the existence of a plurality of such elements. The present disclosure may be realized by hardware including some different elements and computers properly programmed. In claims in which some modules of devices are set forth, some of the devices may be embodied by the same hardware item. The usage of the words “first”, “second” and “third” does not indicate any sequence, and these words may be interpreted as names of elements.

Computer systems/servers may be described under the context of computer-system-executable instructions (for example, program modules) executed by the computer systems. Generally, the program modules may include routines, programs, target programs, components, logics, data structures, and the like, which execute particular tasks or realize particular abstract data types. The computer systems/servers may be implemented in a distributed cloud computation environment, in which tasks are executed by remote processing devices connected via communication networks.

1-15. (canceled)

16. A method for pushing a resource in a smart TV to a mobile communication terminal, wherein the smart TV establishes a communication connection with the mobile communication terminal in advance, the method is applied in the smart TV side and comprises:
determining a target resource which needs to be pushed to the mobile communication terminal, wherein the target resource which needs to be pushed to the mobile communication terminal is a resource locally stored in the smart TV;
obtaining an IP address of the smart TV and a storage path of the target resource in the smart TV;
generating an access address for accessing the target resource according to the IP address and the storage path;
determining the mobile communication terminal requesting the target resource, and sending the access address to the mobile communication terminal via the communication connection; and
when receiving a request for accessing the target resource corresponding to the access address from the mobile communication terminal, sending the target resource to the mobile communication terminal via the communication connection.

17. The method according to claim 16, further comprising:
after receiving the request for accessing the target resource corresponding to the access address from the mobile communication terminal, broadcasting, by an operating system of the smart TV, the request to respective background applications;
wherein when receiving the request for accessing the target resource corresponding to the access address from the mobile communication terminal, the sending the target resource to the mobile communication terminal via the communication connection, comprises:
after receiving the request broadcast by the operating system, determining whether processing the request is authorized; and
if processing the request is authorized, parsing the request, and sending the target resource to the mobile communication terminal via the communication connection.

18. The method according to claim 16, wherein the target resource comprises a video file, an audio file, a picture file or a webpage file;
when the target resource is a video file or an audio file, the method further comprises:
sending play position information of the target resource to the mobile communication terminal.

19. A method for pushing a resource in a smart TV to a mobile communication terminal, wherein the mobile communication terminal establishes a communication connection with the smart TV in advance, the method is applied in the mobile communication terminal side and comprises:
providing a user operation entry in a user interface on the mobile communication terminal;
receiving an access address of a resource sent from the smart TV via the communication connection, wherein the access address is generated by the smart TV according to an IP address of the smart TV itself and a storage path of the resource in the smart TV;
when receiving a request for accessing the resource corresponding to the access address from a user via the user operation entry, parsing the access address, and sending an access request to the smart TV via the communication connection according to a parsing result, wherein the access request carries the access address; and
storing or playing the resource according to network resource data returned from the smart TV.

20. The method according to claim 19, further comprising:
after receiving the access address sent from the smart TV, sending the smart TV information indicating that the access address is received; and
after receiving the network resource sent from the smart TV, sending the smart TV information indicating that the network resource is received.

21. The method according to claim 19, wherein the entry comprises a voice input entry or a key input entry.

22. The method according to claim 19, further comprising:
after receiving the network resource sent from the smart TV, broadcasting, by an operating system of the mobile communication terminal, a message indicating that the network resource is received to respective background applications;
wherein the storing or playing the resource according to network resource data returned from the smart TV, comprises:
after receiving the message broadcast by the operating system, determining whether processing the message is authorized; and
if processing the message is authorized, parsing the message, and storing or playing the resource.

23. A device for pushing a resource in a smart TV to a mobile communication terminal, wherein the smart TV establishes a communication connection with the mobile communication terminal in advance, the device is applied in the smart TV side and comprises:
one or more processors; and
a memory;
wherein one or more programs are stored in the memory, and when executed by the one or more processors, the one or more programs cause the one or more processors to:
determine a target resource which needs to be pushed to the mobile communication terminal, wherein the target resource which needs to be pushed to the mobile communication terminal is a resource locally stored in the smart TV;
obtain an IP address of the smart TV and a storage path of the target resource in the smart TV;
generate an access address for accessing the target resource according to the IP address and the storage path;
determine the mobile communication terminal requesting the target resource, and send the access address to the mobile communication terminal via the communication connection; and
when receive a request for accessing the target resource corresponding to the access address from the mobile communication terminal, send the target resource to the mobile communication terminal via the communication connection.

24. The device according to claim 23, wherein after receiving the request for accessing the target resource corresponding to the access address from the mobile communication terminal, an operating system of the smart TV broadcasts the request to respective background applications; and
wherein the one or more processors are configured to:
after receive the request broadcast by the operating system, determine whether processing the request is authorized; and
if processing the request is authorized, parse the request, and send the target resource to the mobile communication terminal via the communication connection.

25. A device for pushing a resource in a smart TV to a mobile communication terminal, wherein the mobile communication terminal establishes a communication connection with the smart TV in advance, the device is applied in the mobile communication terminal side and comprises:
one or more processors; and
a memory;
wherein one or more programs are stored in the memory, and when executed by the one or more processors, the one or more programs cause the one or more processors to:
provide a user operation entry in a user interface on the mobile communication terminal;
receive an access address of a resource sent from the smart TV via the communication connection, wherein the access address is generated by the smart TV according to an IP address of the smart TV itself and a storage path of the resource in the smart TV;
when receive a request for accessing the resource corresponding to the access address from a user via the user operation entry, parse the access address, and send an access request to the smart TV via the communication connection according to a parsing result, wherein the access request carries the access address; and
store or play the resource according to network resource data returned from the smart TV.

26. The device according to claim 25, wherein the one or more processors are further configured to:
after receive the access address sent from the smart TV, send the smart TV information indicating that the access address is received; and
after receive the network resource sent from the smart TV, send the smart TV information indicating that the network resource is received.

27. The device according to claim 25, wherein the entry comprises a voice input entry or a key input entry.

28. The device according to claim 25, wherein the target resource comprises a video file, an audio file, a picture file or a webpage file.

29. The device according to claim 25, wherein after receiving the network resource sent from the smart TV, an operating system of the mobile communication terminal broadcasts a message indicating that the network resource is received to respective background applications; and
wherein the one or more processors are configured to:
after receive the message broadcast by the operating system, determine whether processing the message is authorized; and
if processing the message is authorized, parse the message, and store or play the resource.

30. A computer readable recording medium, on which programs for performing a method for pushing a resource in a smart TV to a mobile communication terminal are recorded, wherein the smart TV establishes a communication connection with the mobile communication terminal in advance, the method is applied in the smart TV side and comprises:
determining a target resource which needs to be pushed to the mobile communication terminal, wherein the target resource which needs to be pushed to the mobile communication terminal is a resource locally stored in the smart TV;
obtaining an IP address of the smart TV and a storage path of the target resource in the smart TV;
generating an access address for accessing the target resource according to the IP address and the storage path;
determining the mobile communication terminal requesting the target resource, and sending the access address to the mobile communication terminal via the communication connection; and
when receiving a request for accessing the target resource corresponding to the access address from the mobile communication terminal, sending the target resource to the mobile communication terminal via the communication connection.

31. The computer readable recording medium according to claim 30, wherein the method further comprises:
after receiving the request for accessing the target resource corresponding to the access address from the mobile communication terminal, broadcasting, by an operating system of the smart TV, the request to respective background applications;
wherein when receiving the request for accessing the target resource corresponding to the access address from the mobile communication terminal, the sending the target resource to the mobile communication terminal via the communication connection, comprises:
after receiving the request broadcast by the operating system, determining whether processing the request is authorized; and
if processing the request is authorized, parsing the request, and sending the target resource to the mobile communication terminal via the communication connection.

32. The computer readable recording medium according to claim 30, wherein the target resource comprises a video file, an audio file, a picture file or a webpage file;
when the target resource is a video file or an audio file, the method further comprises:
sending play position information of the target resource to the mobile communication terminal.

33. A computer readable recording medium, on which programs for performing a method for pushing a resource in a smart TV to a mobile communication terminal are recorded, wherein the mobile communication terminal establishes a communication connection with the smart TV in advance, the method is applied in the mobile communication terminal side and comprises:
providing a user operation entry in a user interface on the mobile communication terminal;
receiving an access address of a resource sent from the smart TV via the communication connection, wherein the access address is generated by the smart TV according to an IP address of the smart TV itself and a storage path of the resource in the smart TV;
when receiving a request for accessing the resource corresponding to the access address from a user via the user operation entry, parsing the access address, and sending an access request to the smart TV via the communication connection according to a parsing result, wherein the access request carries the access address; and
storing or playing the resource according to network resource data returned from the smart TV.

34. The computer readable recording medium according to claim 33, wherein the method further comprises:
after receiving the access address sent from the smart TV, sending the smart TV information indicating that the access address is received; and
after receiving the network resource sent from the smart TV, sending the smart TV information indicating that the network resource is received.

35. The computer readable recording medium according to claim 33, wherein the method further comprises:
after receiving the network resource sent from the smart TV, broadcasting, by an operating system of the mobile communication terminal, a message indicating that the network resource is received to respective background applications; and
wherein the storing or playing the resource according to network resource data returned from the smart TV, comprises:
after receiving the message broadcast by the operating system, determining whether processing the message is authorized; and
if processing the message is authorized, parsing the message, and storing or playing the resource.
